(19) United States
(12) Patent Application Publication
(10) Pub. No.: US 2024/0334002 A1
(43) Pub. Date: Oct. 3, 2024

(54) VIDEO PROCESSING DEVICE, VIDEO PROCESSING METHOD, AND SCREEN COMPOSITION MEANS

(71) Applicant: LAPIS Technology Co., Ltd., Yokohama (JP)

(72) Inventor: Takuya MOTOHASHI, Yokohama (JP)

(73) Assignee: LAPIS Technology Co., Ltd., Yokohama (JP)

(21) Appl. No.: 18/607,532

(22) Filed: Mar. 17, 2024

(30) Foreign Application Priority Data
Mar. 30, 2023 (JP) 2023-056781

(51) Int. Cl. H04N 21/431

(52) U.S. Cl. CPC H04N 21/4316

(57) ABSTRACT

The disclosure provides a video processing device and a video processing method which make it possible to freely determine the shape of a video to be superimposed. A video processing device includes a screen composition part that performs screen composition so that a plurality of videos are displayed on one panel, and a screen composite video output by the screen composition part includes at least one first video whose width changes for each line among the plurality of videos.

### CROSS-REFERENCE TO RELATED APPLICATION

This application claims the priority benefits of Japanese application no. 2023-056781, filed on Mar. 30, 2023. The entirety of the above-mentioned patent application is hereby incorporated by reference herein and made a part of this specification.

### BACKGROUND

### Technical Field

The disclosure relates to a video processing device, a video processing method, and a screen composition means for displaying videos in a superimposed manner.

### Description of Related Art

In recent years, the number of in-vehicle cameras installed in cars, such as vehicle surrounding monitoring systems, electronic mirrors (or digital mirrors), and drive recorders, has been increasing. In display devices that display videos from the plurality of in-vehicle cameras, screen composition for displaying videos on one panel is performed so that the videos can be checked at a glance.

For example, Patent Document 1 (Japanese Patent Laid-Open No. 2008-1179) discloses an in-vehicle driving support camera device including at least two cameras and a right and left screen composition means that combines right and left image signals of a vehicle obtained by the cameras into right and left display screen signals in order to display right and left images on one screen (claim 1, paragraph 0007, FIGS. 4 and 6).

In this manner, in order to display a plurality of videos on one panel so that they can be checked at a glance, appearance and ease of viewing are important factors. In order to improve these, especially in a mode in which videos are displayed to be superimposed on each other, it is required to be able to freely determine the shape of the superimposed videos, such as displaying the videos with their corners removed.

The disclosure provides a video processing device, a video processing method, and a screen composition means which are capable of freely determining the shapes of videos to be superimposed.

### SUMMARY

The disclosure provides a video processing device including a screen composition part that performs screen composition so that a plurality of videos are displayed on one panel, in which a screen composite video output by the screen composition part includes at least one first video whose width changes for each line among the plurality of videos.

The disclosure provides a video processing method including performing screen composition so that a plurality of videos are displayed on one panel, in which a screen composite video generated in the performing of the screen composition includes at least one video whose width changes for each line among the plurality of videos.

The disclosure provides a screen composition means that superimposes a plurality of videos to display the videos on one panel, the screen composition means outputting a signal group including a data selection signal for changing a width of a video to be superimposed for each line.

### BRIEF DESCRIPTION OF THE DRAWINGS

FIG. 1 is a diagram showing a method of generating a screen composite video according to the disclosure.

FIG. 2 is a diagram showing a video transmission format including a data selection signal.

FIG. 3 is a block diagram showing a configuration of a video processing device 10 according to an embodiment.

FIG. 4 is a flowchart showing processing operations of the video processing device 10 according to the embodiment.

FIG. 5 is a diagram showing a method of generating a screen composite video in a comparative example.

FIG. 6 is a diagram showing a video transmission format including a data enable signal.

FIG. 7 is a diagram illustrating a case where the shape of a video to be superimposed is circular.

### DESCRIPTION OF THE EMBODIMENTS

First, a mechanism for screen composition according to the disclosure will be described. In the drawings, members that are the same or correspond to each other are denoted by the same or similar reference numerals and signs, and repeated description will be omitted.

According to the disclosure, it is possible to provide a video processing device, a video processing method, and a screen composition means which are capable of freely determining the shapes of videos to be superimposed.

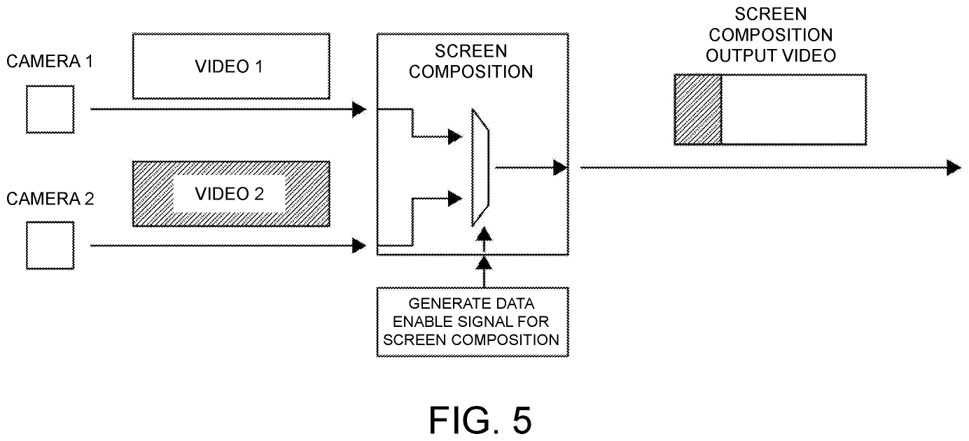

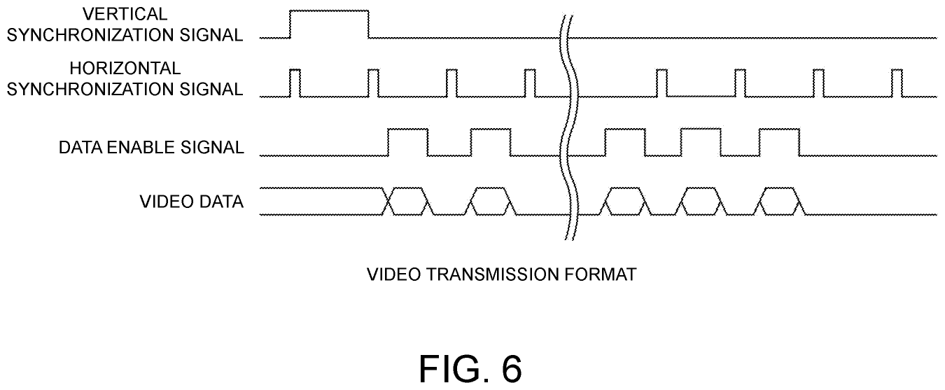

FIG. 5 is a diagram showing a method of generating a screen composite video in a comparative example. Screen composition is performed to superimpose a video 2 (rectangle) transmitted from a camera 2 on a video 1 (rectangle) transmitted from a camera 1 and display them on one panel. During the screen composition, a data enable signal is generated for screen composition. However, as shown in FIG. 6, the data enable signal is a signal in which all scanning lines (all lines) have the same width. In general, in camera video transmission, a video having a rectangular shape is input. For this reason, a data enable signal whose horizontal and vertical widths are also fixed (constant) is usually used. When a data enable signal is used, a video to be superimposed is also fixed in a rectangular shape, and the shape of the video to be superimposed cannot be changed.

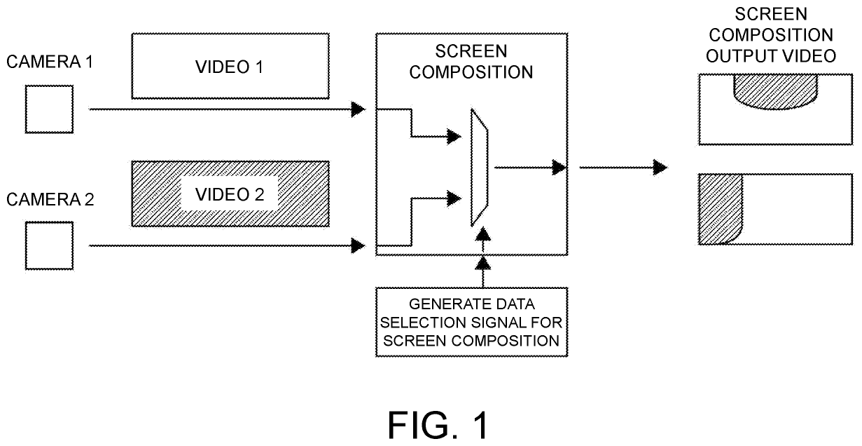

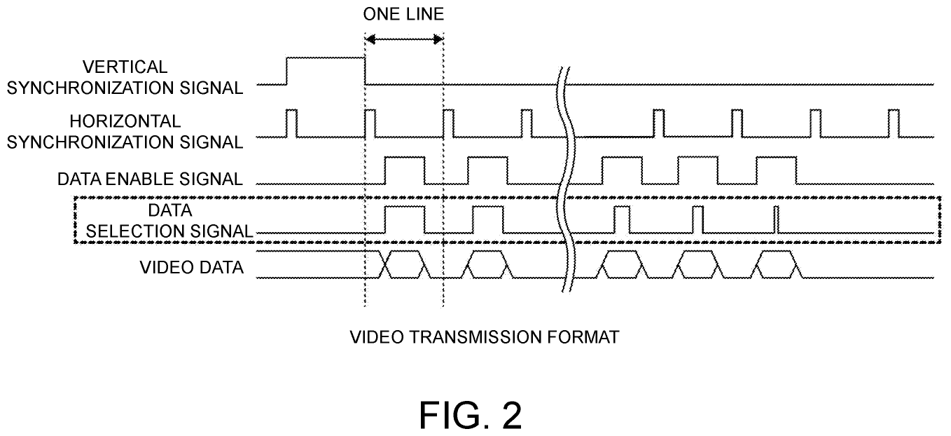

FIG. 1 is a diagram showing a method of generating a screen composite video according to the disclosure. Screen composition is performed to superimpose a video 2 (rectangle) transmitted from a camera 2 on a video 1 (rectangle) transmitted from a camera 1 and display them on one panel. During the screen composition, a data selection signal is generated in addition to the data enable signal for screen composition. As shown in FIG. 2, the data selection signal can have a different width for each line. In this manner, the video 2 transmitted from the camera 2 is output only when the data selection signal input from the outside is, for example, “H.” Then, the width of the video 2 changes for each line, and thus the shape of the video to be superimposed can be changed. In this manner, the width of the superimposed image is designated for each line during screen composition by using the data selection signal, and thus the shape of a video to be superimposed can be freely determined. FIG. 1 shows two types of shapes for the superimposed video 2. For example, the shape of the video 2 to be superimposed may be changed every time. Alternatively, two types of shapes may be displayed on different panels at the same time.

In this specification, “one line” refers to one horizontal scanning line drawn from left to right on a screen of a display device such as a display. “Data selection signal” is a signal for controlling an output of a video to be superimposed by changing the width of “H” (high level) or “L” (low level) for each line. There is no particular limitation on whether the video to be superimposed is output in the case of “H” or the case of “L.” “Video to be superimposed” is a video that is on the upper side (the side of the viewer of the video) when superimposed.

FIG. 2 shows a video transmission format. Signals are as follows. A vertical synchronization signal is a signal for determining the timing of scanning in a vertical direction. A horizontal synchronization signal is a signal for determining the timing of scanning in a horizontal direction. A data enable signal is a signal for determining whether to enable or disable the output of a video. A data selection signal is a signal for determining whether to enable or disable the output of a video, and the width thereof can be freely changed for each line. For this reason, the output of a video to be superimposed can be designated with a different width for each line. Thus, the shape of a video to be superimposed can be freely determined.

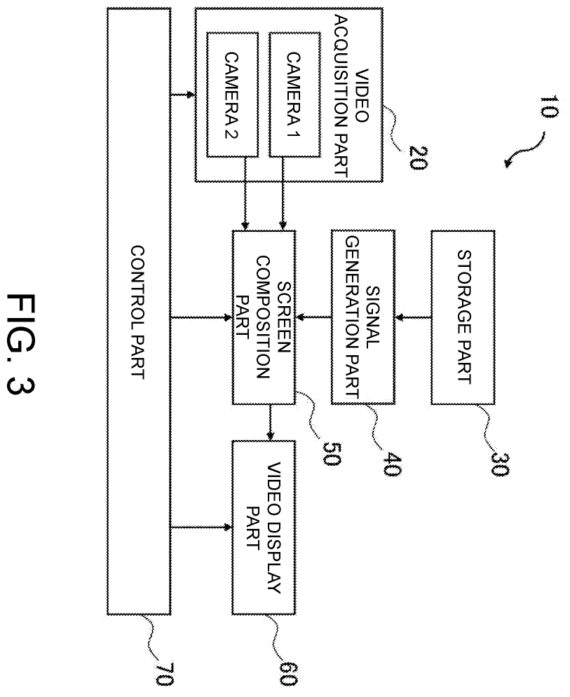

The video processing device 10 according to the embodiment of the disclosure will be described below using FIG. 3. The video processing device 10 may be a computer including a central processing unit (CPU), a read only memory (ROM), and a random access memory (RAM). FIG. 3 is a block diagram showing a configuration of the video processing device 10. The video processing device 10 includes a storage part 30, a signal generation part 40, a screen composition part 50, and a control part 70. The video processing device 10 may further include a video acquisition part 20 and a video display part 60. In the video processing device 10, programs stored in the storage part 30 are executed by the CPU to function as the video acquisition part 20, the signal generation part 40, the screen composition part 50, the video display part 60, and the control part 70. The video processing device 10, which is an in-vehicle device installed in a vehicle such as a car, may be a device that performs screen composition to display a plurality of pieces of video data obtained from an in-vehicle camera or the like serving as the video acquisition part 20 on one panel by the screen composition part 50 and display the video data on a display serving as the video display part 60. Each part will be described below in detail.

The video acquisition part 20 acquires images (that is, videos) that change over time. For example, the video acquisition part 20 may be a general camera mounted on a vehicle. Specifically, examples thereof include a drive recorder camera, a camera that monitors the surroundings of a vehicle such as a camera for displaying the rear view of the vehicle on a car navigation system, and an in-vehicle camera such as an electronic mirror camera. The video acquisition part 20 includes at least two cameras. The number of cameras is not particularly limited.

The storage part 30 may store pattern data of a data selection signal in advance. For example, since the width of a video transmitted from the video acquisition part 20 is already determined, width data of the data selection signal may be stored in the storage part 30 in advance so that a desired shape is obtained based on the width of a video to be superimposed. The shape formed by the data selection signal is not particularly limited. For example, the shape may be a polygon such as a triangle or a pentagon, a star-shaped polygon, an ellipse, a circle, a semicircle, or a fan shape. In this manner, pattern data of a data selection signal to be generated can be stored in advance in the storage part 30 so that a superimposed image has a predetermined shape. A user can freely determine the shape of a video to be superimposed by selecting a shape stored in the storage part 30 by using an external input device (not shown). The storage part 30 may be a storage part constituted by, for example, a nonvolatile semiconductor memory.

The signal generation part 40 generates a data selection signal that designates the output of a video to be superimposed on a line-by-line basis. As an example, the data selection signal may be generated based on the shape stored in the storage part 30. Alternatively, the data selection signal may be formed based on a shape that is directly input by the user using an external input device (not shown).

The screen composition part 50 performs screen composition so that a plurality of pieces of video data received from a plurality of cameras included in the video acquisition part 20 are displayed on one panel. That is, the screen composition part 50 plays the role of a multiplexer. In this manner, the screen composition part 50 receives an input from the video acquisition part 20 and generates and outputs a screen composite video to be displayed on the video display part 60 based on the input.

The video display part 60 displays a screen composite output video transmitted from the screen composition part 50 on a panel. The video display part 60 is not particularly limited and may be constituted by a liquid crystal display panel. An example of the video display part 60 is an in-vehicle display (in-vehicle monitor). Examples of the in-vehicle monitor include an on-dash monitor, a flip-down monitor, a headrest monitor, and the like.

The control part 70 is a processing control part that controls the operation of each of the parts of the video processing device 10. For example, the control part 70 controls ON/OFF of each part. Alternatively, for example, the user selects a video to be superimposed (that is, whose shape is to be changed) from among a plurality of videos via an external input device (not shown), and selects a desired shape from among shapes stored in the storage part 30. Under the control of the control part 70, the signal generation part 40 generates a data selection signal based on pattern data of the data selection signal stored in the storage part 30 for the selected video and the selected shape. The generated data selection signal is transmitted to the screen composition part 50, and the screen composition part 50 outputs a screen composite video. The video display part 60 may display the screen composite video.

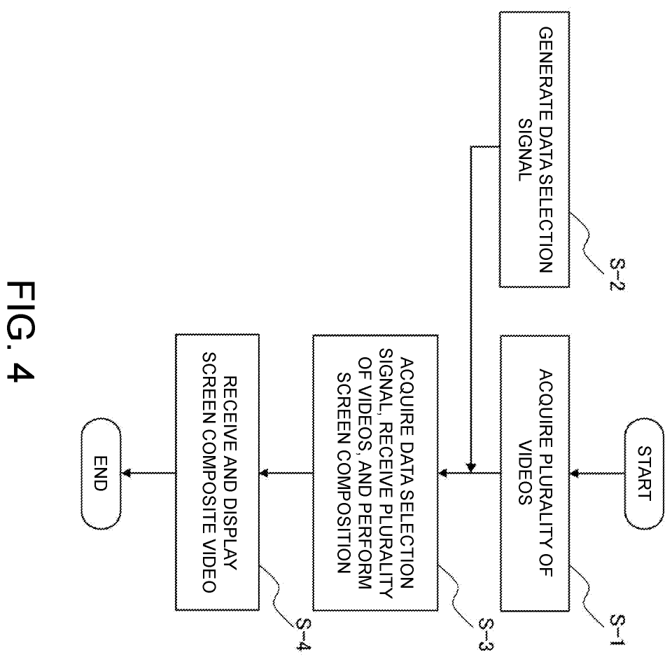

A processing operation of the video processing device 10 in this example will be described with reference to a flowchart of FIG. 4. The video acquisition part 20 acquires a plurality of videos from a plurality of cameras and transmits the acquired videos to the screen composition part 50 (S-1). The signal generation part 40 generates a data selection signal (S-2). The screen composition part 50 receives the plurality of videos from the video acquisition part 20, acquires the data selection signal generated by the signal generation part 40, performs screen composition in order to display the received plurality of videos on one panel, and transmits a screen composite video to the video display part 60 according to the video transmission format shown in FIG. 2 (S-3). The video display part 60 receives the screen composite video and displays it on the panel (S-4).

In the disclosure, a data selection signal is input from the outside, and the horizontal and vertical widths are designated for each line by the data selection signal. A video to be superimposed is output only when the data selection signal is “H” or “L.” In this manner, it is possible to perform screen composition of a semicircle or the like by inputting a data selection signal whose width is changed for each line. For example, the data selection signal may be generated and output such that the shape of a video to be superimposed matches an element included in the video to be superimposed. As an example, the shape of a video to be superimposed may be the shape of a vehicle included in a captured video.

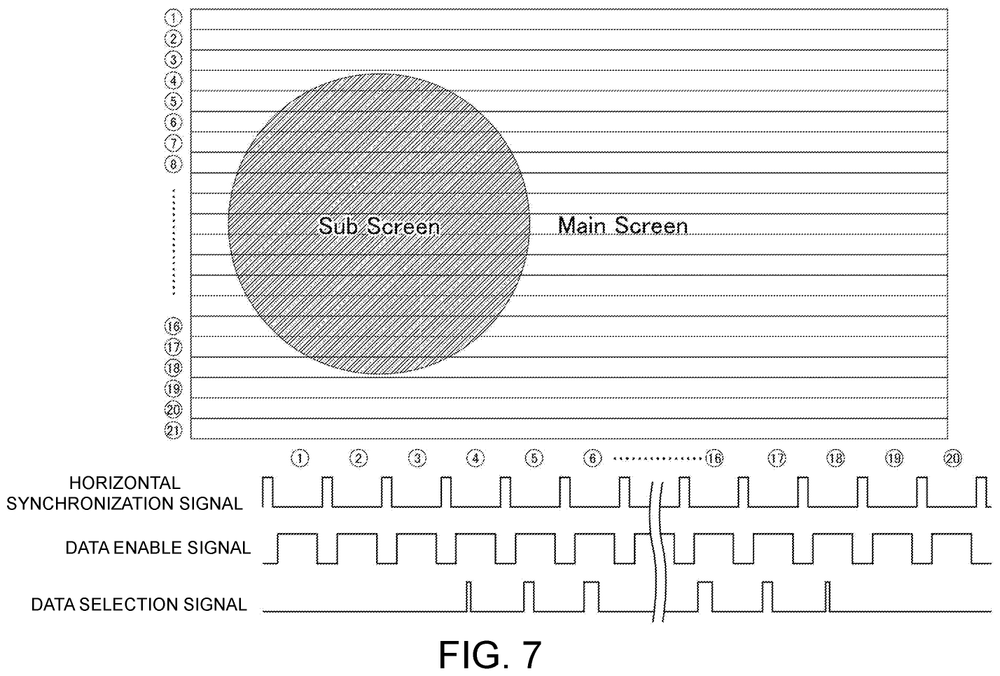

As an example, FIG. 7 shows an example of a screen composite video in which a video to be superimposed as a sub-screen is displayed in a circle on a video displayed on a main screen. 1, 2, 3, . . . , 19, and 20 in FIG. 7 indicate each line (each is one line). As shown in FIG. 7, a data enable signal is “H” with a fixed width for each line, and is generated to output a video with a constant width for each line. On the other hand, the output of a video (superimposed image) to be displayed on the sub-screen is controlled by the data selection signal, and is output in the case of “H” in FIG. 7. For this reason, the video on the sub-screen is displayed such that the width of the video increases gradually from the fourth line, forming an upper semicircle, and similarly, the video is displayed such that the width of the video decreases gradually, forming a lower semicircle. In this manner, the shape of a video to be superimposed is formed.

As described above, a user can freely determine the shape of a video to be superimposed by inputting a data selection signal for screen composition from the outside instead of a data enable signal with uniform horizontal and vertical widths and controlling the output of the video to be superimposed to perform screen composition.

Means for solving the problems of the present application include the following means.

<1> A video processing device including:
a screen composition part that performs screen composition so that a plurality of videos are displayed on one panel,
wherein a screen composite video output by the screen composition part includes at least one first video whose width changes for each line among the plurality of videos.

<2> The video processing device according to <1>, further including a signal generation part that generates a data selection signal for changing the width of the first video to be superimposed for each line and transmits the data selection signal to the screen composition part in screen composition for superimposing videos by the screen composition part.

<3> The video processing device according to <2>, further including a storage part that stores at least one piece of pattern data for a width of the data selection signal.

<4> The video processing device according to any one of <1> to <3>, further including:
a video acquisition part that acquires the plurality of videos; and
a video display part that displays the screen composite video.

<5> A video processing method including:
performing screen composition so that a plurality of videos are displayed on one panel,
wherein a screen composite video generated in the performing of the screen composition includes at least one video whose width changes for each line among the plurality of videos.

<6> The video processing method according to <5>, further including:
acquiring the plurality of videos; and
displaying the screen composite video.

<7> A screen composition means that superimposes a plurality of videos to display the videos on one panel, the screen composition means outputting a signal group including a data selection signal for changing a width of a video to be superimposed for each line.

What is claimed is:

1. A video processing device comprising:
a screen composition part that performs screen composition so that a plurality of videos are displayed on one panel,
wherein a screen composite video output by the screen composition part includes at least one first video whose width changes for each line among the plurality of videos.

2. The video processing device according to claim 1, further comprising:
a signal generation part that generates a data selection signal for changing the width of the first video to be superimposed for each line and transmits the data selection signal to the screen composition part in screen composition for superimposing videos by the screen composition part.

3. The video processing device according to claim 2, further comprising:
a storage part that stores at least one piece of pattern data for a width of the data selection signal.

4. The video processing device according to claim 1, further comprising:
a video acquisition part that acquires the plurality of videos; and
a video display part that displays the screen composite video.

5. The video processing device according to claim 2, further comprising:
a video acquisition part that acquires the plurality of videos; and
a video display part that displays the screen composite video.

6. The video processing device according to claim 3, further comprising:
a video acquisition part that acquires the plurality of videos; and
a video display part that displays the screen composite video.

7. A video processing method comprising:
performing screen composition so that a plurality of videos are displayed on one panel,
wherein a screen composite video generated in the performing of the screen composition includes at least one video whose width changes for each line among the plurality of videos.

8. The video processing method according to claim 7, further comprising:
acquiring the plurality of videos; and
displaying the screen composite video.

9. A screen composition means that superimposes a plurality of videos to display the videos on one panel, the screen composition means outputting a signal group including a data selection signal for changing a width of a video to be superimposed for each line.
